(19) United States
(12) Patent Application Publication
(10) Pub. No.: US 2009/0286207 A1
(43) Pub. Date: Nov. 19, 2009

(54) Dental composite stain

(76) Inventor: Anoop K.S. Bawa, San Ramon, CA (US)

Correspondence Address: THEODORE J. BIELEN JR.;BIELEN, LAMPE, & THOEMING, 1390 WILLOW PASS ROAD, SUITE 1020, CONCORD, CA, 94520, US

(21) Appl. No.: 12/152,710

(22) Filed: May 16, 2008

(51) Int. Cl. A61C 5/00

(52) U.S. Cl. 433/228.1

(57) ABSTRACT

A stain of dental composite material vanishing under the influence of light which utilizes a curcumin containing material. The curcumin containing material is applied to the filling and the tooth to reveal the extent of the filling material relative to the tooth for the purpose of identification.

### BACKGROUND OF THE INVENTION

The present invention relates to a novel and useful stain for dental composite material.

Traditional dental fillings and the like have employed metallic material such as silver, gold, and mercury. Recently composite material have been substituted for the older metallic materials since they enjoy the advantage of mimicking or matching the external coloration of the natural tooth. Unfortunately, composite material which are used for fillings must be removed and replaced for numerous reasons, such as further tooth decay, dramatic damage to the filling, to name a few. In removing such composite fillings, the dental practitioner must discern the position and extent of the composite material relative to the natural tooth. This is often a very difficult task since removal of natural tooth material with the composite material can cause exacerbated damage to the natural tooth necessitating more extensive dental work to repair the same.

In the past, many compositions, including dental compositions, concerning coloration and light sensitivity have been proposed. For example, U.S. Pat. No. 7,247,659 discloses a photo sensitive resin material for imaging purposes.

U.S. Pat. Nos. 4,177,563, 6,386,865 and 7,148,267 show composite materials which may be used for dental restoratives prostheses and repairs.

U.S. Pat. No. 5,588,834 shows a system for color matching a dental prosthesis.

U.S. Pat. Nos. 4,150,485 5,125,970 and US Publication No. US2008/0057298 describe coatings which may be employed with dental enamel.

U.S. Pat. Nos. 6,719,839 and 7,229,490 show chemical compositions and coloring agents utilizing curcumin.

United States Patent Publication US2002/0119100 describes use of a fluorescein dye to identify dental caries.

United States Patent Publication 2007/0280888 describes a dental plaque detection system which employs extracts of curcumin. A light-emitting apparatus is also used to help in the identification of dental plaque.

U.S. Pat. Nos. 6,579,096 and 6,960,084 describe a method for staining dental composite materials. The methods employ a disclosing agent which bonds to the composite filling causing identification of the same. The disclosing agent utilizes a halogen which is activated by ultraviolet light or heat.

A quick acting temporary stain of dental composite material vanishing under the influence of light would be a notable advance in the dental field.

### BRIEF SUMMARY OF THE INVENTION

In accordance with the present invention a novel and useful temporary stain for dental composite material is hereinafter described.

The stain of the present invention utilizes a curcumin containing material such as turmeric, curcumin derivatives, the finally divided rhizome of the curcuma longa plant and similar entities. The curcumin may be of the keto or enol form, the former being preferred when curcumin is in a solid phase and the latter when curcumin is in a solution. Curcumin containing turmeric may also be employed in its a dry, finally divided natural form, or in a slurry form created by mixing such solid forms of turmeric with a solvent such as water.

The present invention may also be deemed to include a method in which the presence of a dental composite material is defined. Such method includes a step of a applying a curcumin containing material to the composite material and the natural associated tooth. The composite made material may take the form of a dental filling which is normally embedded in the natural tooth or a protuberance which is bonded to the exterior of the natural tooth. The latter may be employed to identify composite stubs to found in orthodontic procedures. After application of the curcumin containing material, the dental practitioner would observe the extent of the dental composite material relative to the natural tooth. This occurs since the composite material has a greater affinity for the stain of the present invention than the natural tooth. In addition, the natural tooth may be wiped or washed clean of any of the stain material of the present invention, leaving the composite material in a state of coloration. Moreover, the method of the present invention may further include the step for removing a least a portion of the composite filling or stubs and reapplying the curcumin containing material to the remaining composite material. This step is performed until further staining does not, occur indicating the absence of composite material relative to the natural tooth.

It may be apparent that a new and useful dental composite stain and method for identifying dental composite relative to a natural tooth has been hereinabove described.

It is therefore an object of the present invention to provide a temporary stain for dental composite material in which the stain is applied topically to natural teeth and reveals the extent or outline of the composite material contained therein.

Another object of the present invention is to provide a temporary stain for the dental composite material in which the stain is applied to both natural enamel and composite filling material and is easily removed from the natural tooth.

Another object of the present invention is to provide a temporary stain of dental composite material which is readily available and does not possess lightfast qualities.

A further object of the present invention is provide a temporary stain of dental composite material which may be utilized in solid, liquid or slurry forms.

A further object of the present invention is to provide a method of revealing the presences of dental composite material which includes applying a curcumin containing material to the composite material and the associated natural tooth and observing the presence of the composite material revealed thereby.

A further object of the present invention is to provide a temporary dental stain and method for revealing dental composite material in which the composite material is either in the form of a dental filling or a protuberance bonded to natural enamel.

Yet another object of the present invention is to provide a temporary stain of dental composite material and a method of using the same which prevents a dental practitioner from removing material of the natural tooth and avoiding more extensive dental procedures, such as root canals.

Another object of the present invention is to provide a temporary stain of dental composite material which does not require activating agents or activation steps to be effective.

The invention possesses other objects and advantages especially as concerns particularly characteristics and features thereof which will become apparent as specification continues.

### BRIEF DESCRIPTION OF THE SEVERAL VIEWS OF THE DRAWING

FIG. 1 is a chemical rendition of curcumin and its keto form.

FIG. 2 is a chemical rendition of curcumin in its enol form.

FIG. 3 is a front elevational view of a typical tooth structure showing a stained composite filling and a stained composite stud.

FIG. 4 is a block diagram outlining the method of the present invention.

For a better understanding of the invention reference is made to the following detailed description of the preferred embodiments of the invention which should be taken in conjunction with the above described drawings.

### DETAILED DESCRIPTION OF THE PREFERRED EMBODIMENTS OF THE INVENTION

Various aspects of the present invention will evolve from the following detailed description of the preferred embodiments thereof which should be referenced to the prior described drawings.

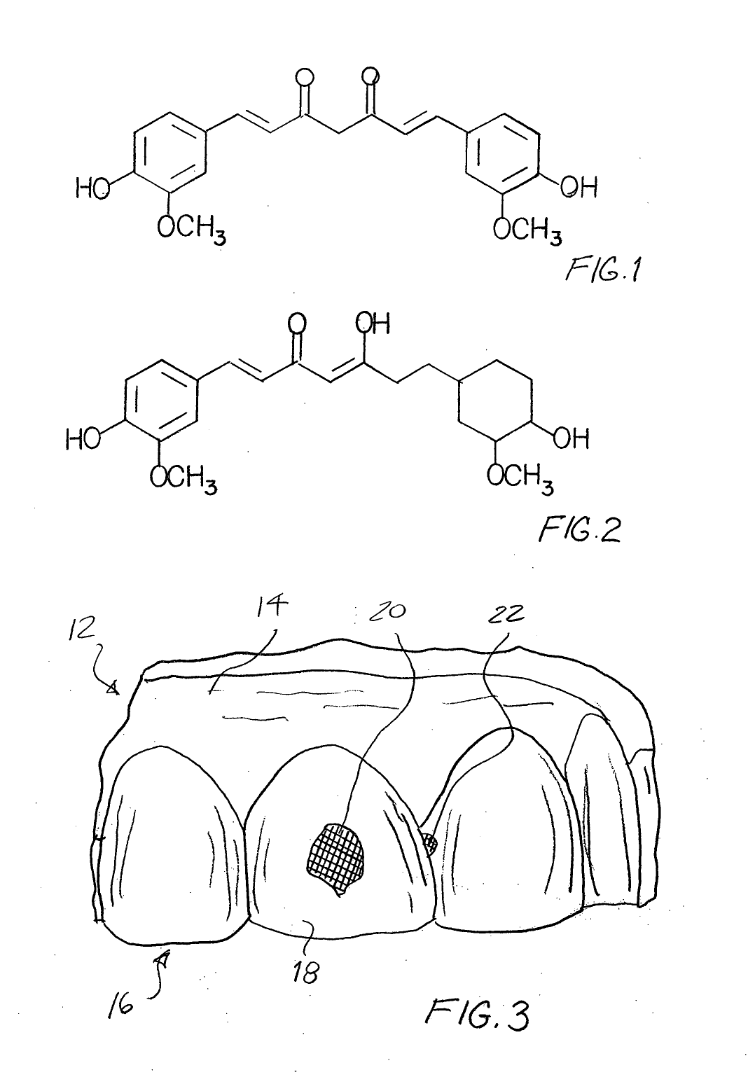

The chemical entity employed in the present invention utilizes a curcumin containing material, With reference to FIGS. 1 and 2, the keto and enol forms of curcumin are described, respectively. It has been found that application of curcumin containing materials to composite materials used in dentistry is capable of staining such composite materials without staining enamel on the normal tooth.

It should also be realized that curcumin containing materials include turmeric or the rhizome of the curcuma longa plant. In many cases, curcumin containing material, such as turmeric may be used in a liquid solution, as a powder or as a slurry where a small amount of solvent, such as water, is combined with turmeric to form the same.

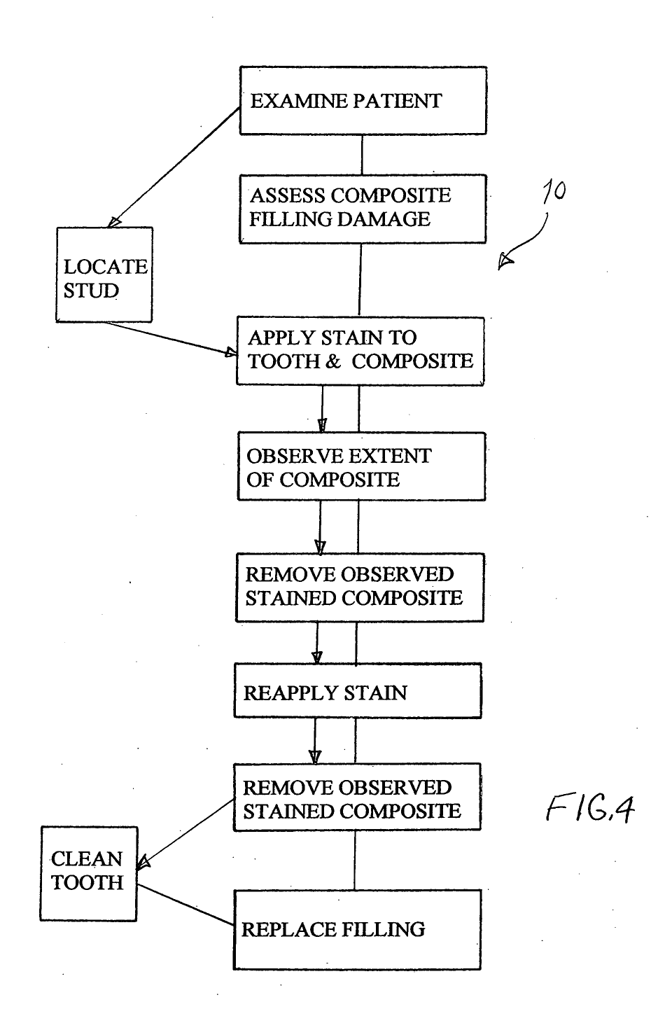

FIG. 3 shows a portion of a mouth structure 12 having gum 14 and a plurality of teeth 16 depending therefrom. With reference to tooth 18 it may be observed that a composite filling 20 lies at the side portion of tooth 18. In addition, a stud 22 is depicted for the sake of the illustration on tooth 18, although, filling 20 and stud 22 are found on teeth such as plurality of teeth 16, and not normally on the same tooth. Stud 22 is formed of a composite material and is generally used in orthodontic procedures. Needless to say, filling 20 and stud 22 have been stained by the curcumin containing material of the present invention and appear as cross-hatched areas in order to emphasize the fact that they are easily discernable relative to the enamel found on the remaining portion of tooth 18. As might be expected, a dental practitioner is able to observe the extent of filling 20 or stud 22 and is able to remove the same should the need occur. In the case of filling 20, the removal would be required when there is damage or deterioration of filling 20 following its placement. Stud 22 would need to be removed when orthodontic procedures have concluded.

Turning to FIG. 4, it may be observed that a method 10 is depicted and is normally followed by a dental practitioner with respect to the present invention. Such steps include the examination of a patient and locating the damaged tooth filling 20 or the presence of stud 22. The curcumin containing material of the present invention is applied to the filling 20 or to stud 22 which allows the practitioner to observe the extent of either item, relative to a natural tooth prior discussed with respect to FIG. 3. The filling 20 or stud 22 is then removed by carefully drilling or the like on filling 20 or stud 22. At a certain point, the stain applied to filling 20 or stud 22 would disappear when the material has been removed. The practitioner would then reapply the stain of the present invention and repeat the removal step until no composite material remains. Sunlight or ultraviolet light will cause any remaining stain to vanish.

It should be realized that composite material used for filling 20 and stud 22 are normally composed of an organic polymer such as bisphenol-A-glycidyl methacrylate (BIS-GMA), combined with in organic materials such as quartz, glass, borosilicate, aluminum silicate lithium aluminum silicate and the like. It is asserted that the stain and method of the present invention permits a dental practitioner to accurately to remove composite material from a natural tooth without damaging the natural tooth.

The following Examples are provided to illustrate the present invention, but are not deemed to limit the scope of the invention in any manner.

### Example 1

A piece of composite material (BIS-GMA) was obtained and sliced into disc shaped pieces about 2 ml in thickness. A turmeric powder was diluted with enough water to form a slurry following stirring of the same. The slurry was then applied to the composite pieces and was allowed to set for about 1 to 2 minutes. Following this time, the turmeric slurry was washed away by water and a distinctive yellow stain appeared on the composite pieces.

### Example 2

A patient having a damaged composite filling was examined by a dental practitioner. A turmeric slurry was applied to the tooth of the patient having the composite filling. After letting the material set for 1 to 2 minutes, excess turmeric liquid was washed from the tooth and plaque was also removed in the vicinity of the tooth. The composite filling was observed to be about 3 ml in diameter and generally circular in configuration on the side of the tooth, which was a lower left molar. The yellow stain appeared distinctive and allowed the dental practitioner to drill out the stained composite filling. The stain was reapplied to the composite filling and such filling was re-drilled until the composite filling was completely removed. Such reapplication of the stain occurred multiple times. Following removal of the filing, another composite filling was successfully placed in the patients tooth.

### Example 3

Pieces of composite material were again formed, as in Example 1. Curcumin containing material was applied to the pieces of composite material and left on a table adjacent to a window. Sunlight was allowed to contact the stained composite material for several hours. After this time period it was noted that the stain on the composite material had vanished indicating that the staining material of the present invention was not colorfast.

### Example 4

A rhizome of the curcuma longa plant was obtained and was ground into finely divided particles. The ground rhizome was then combined with water to formed a slurry and applied to dental composite material, as was noted in Example 1. After 1 to 2 minutes, it was observed that the composite material stained yellow. This application was repeated using henna. After such application of henna, it was observed that the dental composite material did not satisfactory stain.

### Example 5

The curcumin containing material of the present invention, in the form of a turmeric in a slurry, was applied to a composite stud on the surface of the tooth. After washing away excess turmeric material, it was observed that the stud stained yellow and was clearly observable in relation to the remaining enamel of the natural tooth.

While in the foregoing, embodiments of the present invention have been set forth in considerable detail for the purposes of making a complete disclosure of the invention, it may be apparent to those of skill in the art that numerous changes may be made in such detail without departing from the spirit and principles of the invention.

What is claimed is:

1. A temporary stain of dental composite material vanishing under the influence of light,
comprising:
a curcumin containing material

2. The stain of claim 7 in which said curcumin containing material comprises purified turmeric.

3. The stain of claim 1 in which said curcumin containing material comprises a finely divided rhizome of the cureuma longa/plant.

4. The stain of claim 1 in which said curcumin consists of the chemical structure selected from the group depicted in FIG. 1 and FIG. 2.

5. The stain of claim 1 in which said curcumin containing material is combined with a liquid to form a slurry.

6. A method of revealing the presence of composite material comprising:
the steps of:
a. applying a curcumin containing material to the composite material and associated natural tooth; and
b. observing the extent of said dental composite material relative to the natural tooth.

7. The method of claim 6 which further comprises the step of:
a removing, said curcumin from said natural tooth.

8. The method of claim 6 in which the dental composite material serves as a dental filling.

9. The method of claim 6 in which the composite material is bonded to the exterior of the natural tooth.

10. The method of claim 8 which includes the further steps of a removing at least a portion of said filling; and
a. applying a curcumin containing material to the composite material and associated natural tooth.
